(19) United States
(12) Patent Application Publication
(10) Pub. No.: US 2006/0153299 A1
(43) Pub. Date: Jul. 13, 2006

(54) Coded video sequence conversion apparatus, method and program product for coded video sequence conversion

(75) Inventors: Tatsuaki Iwata, Kawasaki-shi (JP); Shinichiro Koto, Kokubunji-shi (JP); Wataru Asano, Yokohama-shi (JP); Tomoya Kodama, Kawasaki-shi (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 11/322,217

(22) Filed: Jan. 3, 2006

(30) Foreign Application Priority Data
Jan. 7, 2005 (JP) P2005-002857

(51) Int. Cl. H04N 11/02; H04N 11/04; H04N 7/12; H04B 1/66

(52) U.S. Cl. 375/240.16; 375/240.24; 375/240.2; 375/240.12

(57) ABSTRACT

A decoding section generates a decoded image and a coding parameter set from a first video coded video sequence. A coding parameter set conversion section first sets the coding structure for a pair of upper and lower macro blocks based on the coding structures of the corresponding macro blocks and converts the remaining parameters such as a motion vector based on the coding structure. A coding parameter set generation section generates coding parameters of an intraframe coding parameter, etc., a coding parameter set selection section selects an optimum parameter set, and a coding section performs recoding processing.

### RELATED APPLICATION(S)

The present disclosure relates to the subject matter contained in Japanese Patent Application No. 2005-002857 filed on Jan. 7, 2005, which is incorporated herein by reference in its entirety.

### BACKGROUND

1. Field of the Invention

This invention relates to a coded video sequence conversion apparatus, a coded video sequence conversion method, and a coded video sequence conversion program.

2. Description of the Related Art

When converting a first video coded video sequence into a second video coded video sequence different from the first video coded video sequence in bit rate and coding system, a coded video sequence conversion apparatus in a related art extracts coding parameters contained in the first video coded video sequence and adaptively selects and uses the coding parameter suited to recoding to the second video coded video sequence, thereby reducing the calculation amount required for recoding, as disclosed in JP-A-2003-009158.

Encoding systems used for compression coding of a video image include MPEG-2 (Moving Picture Experts Group Phase 2) video system, MPEG-4 visual system, H.264 as the international standard in ITU-T (International Telecommunication Union-Telecommunication Standardization Sector), and the like. In these coding systems, one picture is divided into processing units called macro blocks having the size defined and coding parameters of a motion vector and a coding mode are set for each macro block.

To encode an input signal of interlaced scanning according to the coding system mentioned above, how to handle the signal may vary from one coding system to another. For example, in the MPEG-2 video system, the coding structure can be switched between a field structure and a frame structure for coding for each picture or for each macro block.

On the other hand, in an H.264 system, to switch the coding structure in picture units, coding is performed as with the MPEG-2; however, to switch the coding structure in macro block units, a coding method called MB-AFF (Macro Block-Adaptive Frame-Field Coding) is used.

In the coding method called MB-AFF, a processing unit called a macro block pair of two macro blocks vertically arranged from top to bottom is used for management, and the coding structure is switched between the field structure and the frame structure in macro block pair units. Thus, several limiting conditions occur such that the upper and lower macro blocks contained in each macro block pair must match in coding structure and that the coding parameters of a top filed and a bottom field must be managed separately for the upper and lower macro blocks.

Thus, to convert an input signal of interlaced scanning from a video coded video sequence subjected to compression coding in MPEG-2 into a video coded video sequence in the coding format of H.264, in the related art, the macro block coding parameters are set for each macro block and therefore it is impossible to efficiently set the macro block pair coding parameters while satisfying the limiting conditions on the macro block pair.

As described above, in the conventional code conversion system, efficient conversion cannot be executed from the macro block coding parameters in the first video coded video sequence to the coding parameters of a macro block pair in the second video coded video sequence.

### SUMMARY

The present invention is directed to a video coded video sequence conversion apparatus, a video coded video sequence conversion method, and a video coded video sequence conversion program wherein when the coding parameter set of each macro block pair in a second video coded video sequence is determined, a plurality of macro blocks in a first video coded video sequence corresponding to the macro block pair are detected and the coding parameter set of the macro block pair is set at a time using the coding parameter sets of the corresponding macro blocks, whereby information on the first video coded video sequence is applied to coding of the second video coded video sequence more efficiently for making it possible to realize high coding efficiency.

According to a first aspect of the invention, there is provided a coded video sequence conversion apparatus for converting a first bitstream provided by performing compression coding of a video signal of interlaced scanning in macro block units into a second bitstream based on a coding system subjected to compression coding in macro block units. The coded video sequence conversion apparatus includes: a decoding section that decodes a first code sting to provide a decoded image and a first coding parameter set; a coding parameter set conversion section that converts, for each of pairs of macro blocks concerning the second bitstream adjacent to each other in a vertical direction on the decoded image, the first coding parameter set of each of corresponding macro blocks concerning the first bitstream corresponding to each pair on the decoded image to find a conversion coding parameter set; a coding parameter set selection section that selects the conversion coding parameter set found relative to the pair as a second coding parameter set of each of the macro blocks of the pair; and a coding section that performs compression coding of the decoded image using the second coding parameter set selected by said coding parameter set selection section to generate the second bitstream.

According to a second aspect of the invention, there is provided a coded video sequence conversion method for converting a first bitstream provided by performing compression coding of a video signal of interlaced scanning in macro block units into a second bitstream based on a coding system subjected to compression coding in macro block units. The method includes: a decoding step of decoding the first code sting to provide a decoded image and a first coding parameter set; a coding parameter set conversion step of converting, as for a pair of macro blocks of the second bitstream adjacent to each other in a vertical direction on the decoded image, the first coding parameter set of each of corresponding macro blocks of the first bitstream corresponding to the pair on the decoded image to find a conversion coding parameter set; a coding parameter set selection step of selecting the conversion coding parameter set found relative to the pair as a second coding parameter set of each of the macro blocks of the pair; and a coding step of performing compression coding of the decoded image using the second coding parameter set selected in said coding parameter set selection step to generate the second bitstream.

According to a third aspect of the invention, there is provided a computer-readable program product for causing a computer system to execute processing of converting a first bitstream provided by performing compression coding of a video signal of interlaced scanning in macro block units into a second bitstream based on a coding system subjected to compression coding in macro block units. The program product causes the computer system to execute process including: a decoding step of decoding the first code sting to provide a decoded image and a first coding parameter set; a coding parameter set conversion step of converting, as for a pair of macro blocks of the second bitstream adjacent to each other in a vertical direction on the decoded image, the first coding parameter set of each of corresponding macro blocks of the first bitstream corresponding to the pair on the decoded image to find a conversion coding parameter set; a coding parameter set selection step of selecting the conversion coding parameter set found relative to the pair as a second coding parameter set of each of the macro blocks of the pair; and a coding step of performing compression coding of the decoded image using the second coding parameter set selected in said coding parameter set selection step to generate the second bitstream.

### BRIEF DESCRIPTION OF THE DRAWINGS

In the accompanying drawings:

FIG. 1 is a block diagram to show a video coded video sequence conversion apparatus according to a first embodiment;

FIG. 2 is a flowchart to show the operation of the video coded video sequence conversion apparatus according to the first embodiment;

FIG. 3 is a flowchart to show processing of a coding parameter set conversion section in the first embodiment;

FIG. 4 is a drawing to show the relationship between a macro block pair and macro blocks corresponding thereto in the first embodiment;

FIG. 5 is a flowchart to show coding structure setting processing of macro blocks in the first embodiment;

FIG. 6 is a flowchart to show coding structure setting processing of a macro block pair in the first embodiment;

FIG. 7 is a flowchart to show parameter conversion processing of macro blocks corresponding to a macro block pair in the first embodiment;

FIG. 8 is a drawing to show a conversion example when the coding structures of the macro blocks and the macro block pair differ in the first embodiment (frame structure to field structure);

FIG. 9 is a drawing to show conversion of motion vectors and motion compensation block shapes the coding structure of the macro block pair is frame structure in the first embodiment;

FIG. 10 is a drawing to show conversion of motion vectors and motion compensation block shapes the coding structure of the macro block pair is field structure in the first embodiment;

FIG. 11 is a flowchart to show a processing flow of a coding parameter set selection section in the first embodiment;

FIG. 12 is a block diagram to show a video coded video sequence conversion apparatus according to a second embodiment;

FIG. 13 is a drawing to show the relationship between one macro block pair and the macro blocks corresponding thereto in the second embodiment;

FIG. 14 is a flowchart to show a flow of coding structure setting processing of a macro block pair in the second embodiment;

FIG. 15 is a block diagram to show a video coded video sequence conversion apparatus according to a third embodiment;

FIG. 16 is a drawing to show a conversion example of picture coding type according to the third embodiment;

FIG. 17 is a drawing to show another conversion example of picture coding type according to the third embodiment;

FIG. 18 is a drawing to show an example of a correspondence ratio in macro blocks that corresponds to the macro block pair of the second embodiment;

FIG. 19 is a flowchart to show another flow of coding structure setting processing of a macro block pair in the second embodiment;

FIG. 20 is a flowchart to show another flow of coding structure setting processing of a macro block pair in the second embodiment;

FIG. 21 is a flowchart to show another flow of coding structure setting processing of a macro block pair in the second embodiment.

### DETAILED DESCRIPTION OF THE EMBODIMENTS

Referring now to the accompanying drawings, there are shown preferred embodiments of the invention.

### First Embodiment

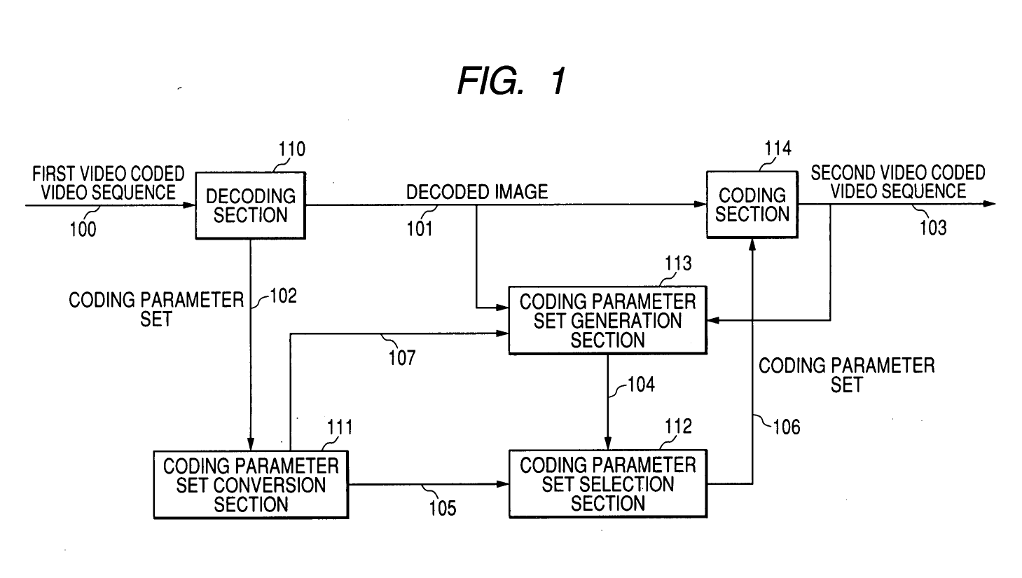

FIG. 1 is a block diagram to show a video coded video sequence conversion apparatus according to a first embodiment.

The video coded video sequence conversion apparatus according to the first embodiment includes:

a decoding section 110 for decoding a first video coded video sequence 100 of input and generating a decoded image 101 and extracting a coding parameter set 102;

a coding parameter set conversion section 111 for analyzing the coding parameter set 102 and converting the coding parameter set in conformity with the coding format of a second video coded video sequence;

a coding parameter set generation section 113 for generating a coding parameter candidate set 104 using the decoded image 101 and already coded second video coded video sequence 103;

a coding parameter set selection section 112 for selecting a coding parameter set 106 finally used for coding from a coding parameter set 105 provided by the coding parameter set conversion section 111 and the coding parameter candidate set 104 generated by the coding parameter set generation section 113; and

a coding section 114 for generating second video coded video sequence using the coding parameter set 106 selected by the coding parameter set selection section 112.

In the embodiment, particularly a first video coded video sequence provided by coding a video image signal of interlaced scanning using MPEG-2 coding system is used. The case where MPEG-4 AVC is used as a second video image coding signal will be discussed.

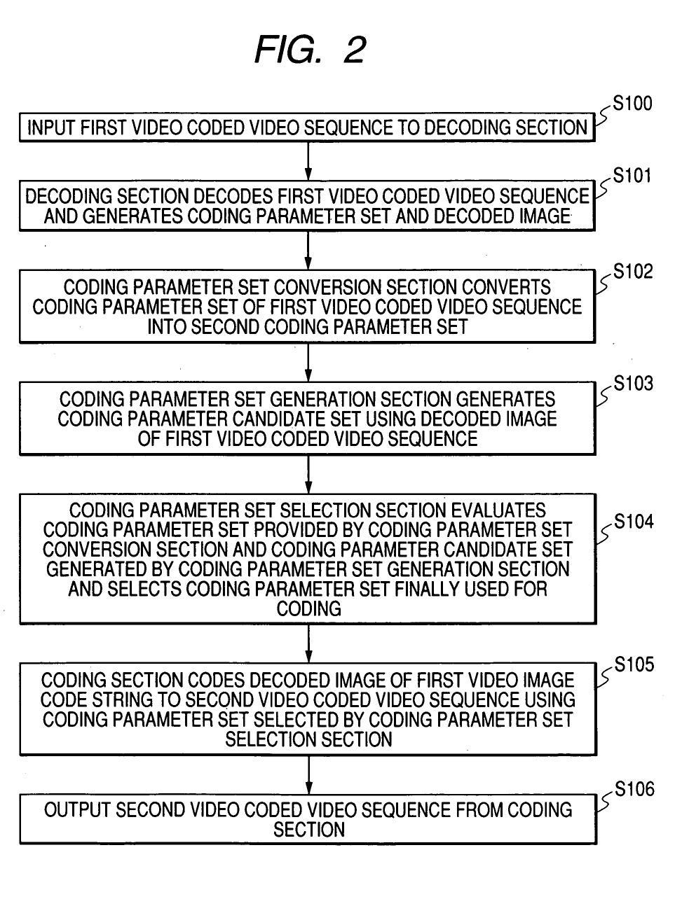

Next, the operation of the video coded video sequence conversion apparatus according to the first embodiment will be discussed with FIGS. 1 and 2. FIG. 2 is a flowchart to show the operation of the video coded video sequence conversion apparatus according to the first embodiment.

The first video coded video sequence 100 is input to the decoding section 110 (step S100).

The decoding section 110 decodes the first video coded video sequence 100 and generates the coding parameter set 102 and the decoded image 101 (step S101).

The coding parameter set conversion section 111 converts the coding parameter set 102 of the first video coded video sequence 100 into the second coding parameter set 105 (step S102).

The coding parameter set generation section 113 generates the coding parameter candidate set 104 using the decoded image 101 of the first video coded video sequence and the already coded second video coded video sequence 103 (step S103).

The coding parameter set selection section 112 evaluates the coding parameter set 105 provided by the coding parameter set conversion section 111 and the coding parameter candidate set 104 generated by the coding parameter set generation section 113 and selects the coding parameter set 106 finally used for coding (step S104).

The coding section 114 codes the decoded image 101 of the first video coded video sequence to the second video coded video sequence 103 using the coding parameter set 106 selected by the coding parameter set selection section 112 (step S105) and outputs the second video coded video sequence 103 (step S106).

Code information 107 provided when the coding parameter set conversion section 111 converts the coding parameter set extracted from the first video coded video sequence 100 may be input to the coding parameter set generation section 113 for use as reference data to generate the coding parameter set.

The processing sections in FIG. 1 will be discussed below in detail.

The decoding section 110 decodes the input video coded video sequence 100 and extracts the coding parameter set 102 contained in the first video coded video sequence 100 and the decoded image 101.

In a case in which the first video coded video sequence 100 is MPEG-2, the extracted coding parameter set 102 contains information including:

resolution information representing the size in width and height of the decoded image contained in the bitstream;

progressive information indicating whether or not the whole bitstream is progressive scanning;

picture type of picture (intraframe coding (I picture), interframe coding (P picture, B picture));

coding structure of picture (frame, field);

coding mode of macro block (intraframe coding, interframe coding);

motion vector indicating referenced part in motion prediction of macro block;

block shape at macro block motion compensation time;

DCT type existing if macro block is intraframe coding;

prediction type existing if macro block is interframe coding; and

field select indicating which field the motion vector of macro block references.

The decoding section 110 of the embodiment extracts the above listed pieces of information as the coding parameter set 102.

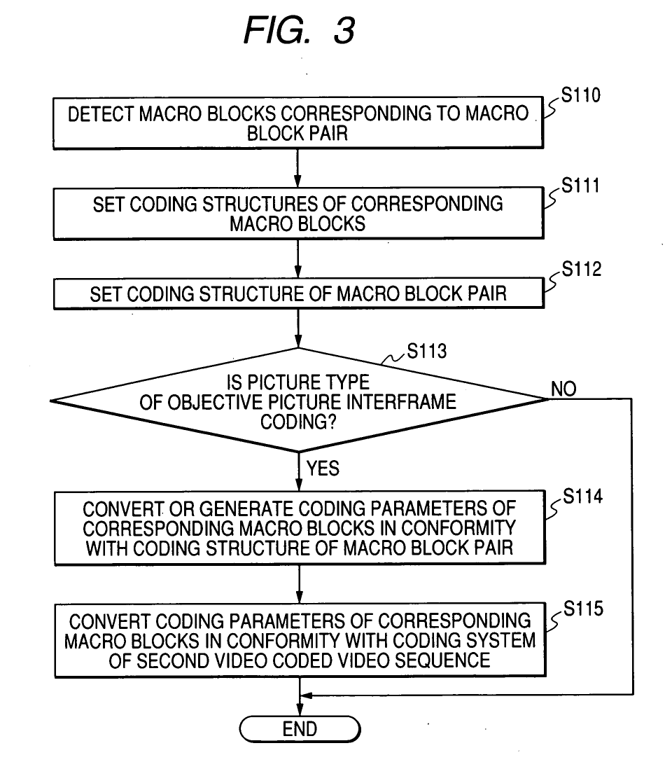

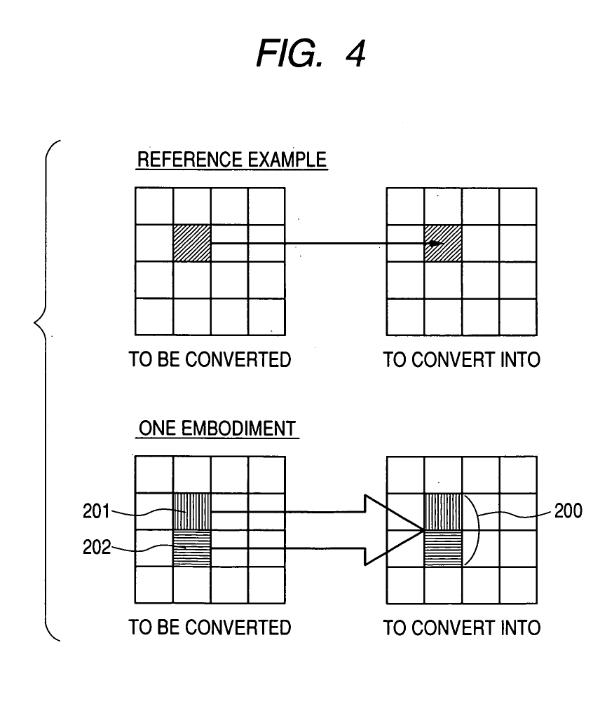

FIG. 3 shows a processing flow of the coding parameter set conversion section 111.

The coding parameter set conversion section 111 finds the macro blocks corresponding to a macro block pair (step S110).

The coding parameter set conversion section 111 determines the coding structures of the macro blocks and the macro block pair, namely, frame structure coding or field structure coding is determined based on the corresponding macro blocks (step S111 and S112).

The coding parameter set conversion section 111 compares the determined coding structures of the macro block pair and the corresponding macro blocks (step S113). If a contradictory parameter or a lack parameter exists, parameter is converted or generated (step S114).

The coding parameter set conversion section 111 converts the coding parameters of the corresponding macro blocks in conformity with the coding system of the second video coded video sequence (step S115) and outputs the provided parameters as a coding parameter candidate set in generating the second video coded video sequence.

The processing in FIG. 3 will be discussed below in detail.

S110: Detect Corresponding Macro Blocks

The macro blocks corresponding to a macro block pair are found. In the embodiment, resolution conversion processing is not involved, the resolution of the first video coded video sequence is the same as that of the second video coded video sequence, and the coding systems of both the first and second video coded video sequences also match in macro block size and therefore two macro blocks 201 and 202 to be converted, of the first video coded video sequence correspond to a macro block pair 200 to convert into in the second video coded video sequence.

S111: Set Coding Structures of Corresponding Macro Blocks

The coding structures of the corresponding macro blocks are found. In the invention, the coding structure is defined as either the field structure or the frame structure.

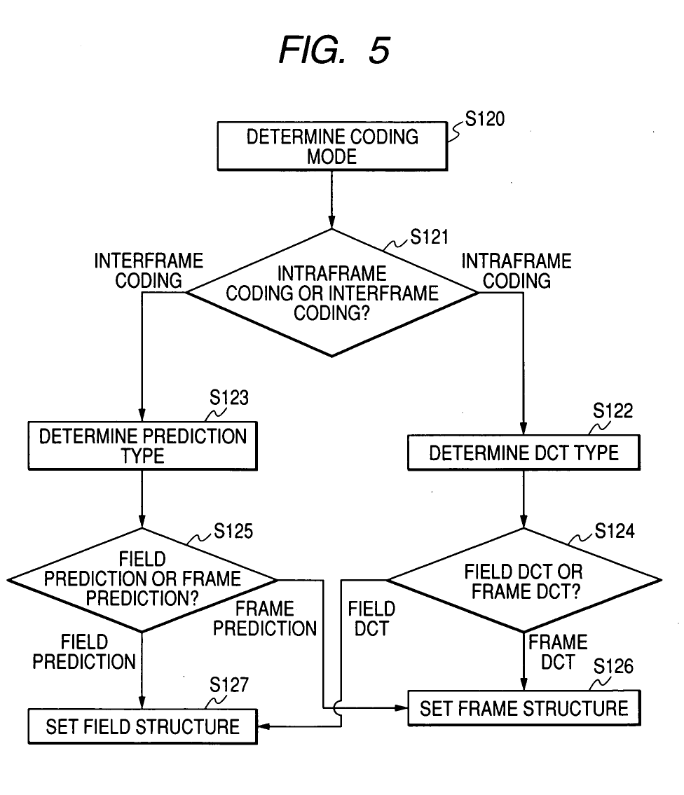

FIG. 5 shows a specific determination method of the coding structure. First, the coding mode of each macro block is analyzed (step S120) and whether the coding mode is intraframe coding (Intra) or interframe coding (NonIntra) is determined (step S121).

In a case in which the coding mode is interframe coding, information of the prediction type contained in the macro block is analyzed (steps S123 and S125). In a case in which the prediction type is field prediction, the field structure is set (step S127); in a case in which the prediction type is frame prediction, the frame structure is set (step S126).

In a case in which the coding mode of the macro block is intraframe coding, information of the DCT type of the macro block is analyzed (steps S122 and S124). In a case in which the DCT type is field DCT, the field structure is set (step S127); if the DCT type is frame DCT, the frame structure is set (step S126).

S112: Determine Coding Structure of Macro Block Pair

After completion of determining the coding structures of the corresponding macro blocks, the coding structure of the macro block pair is determined based on the coding structures of the corresponding macro blocks.

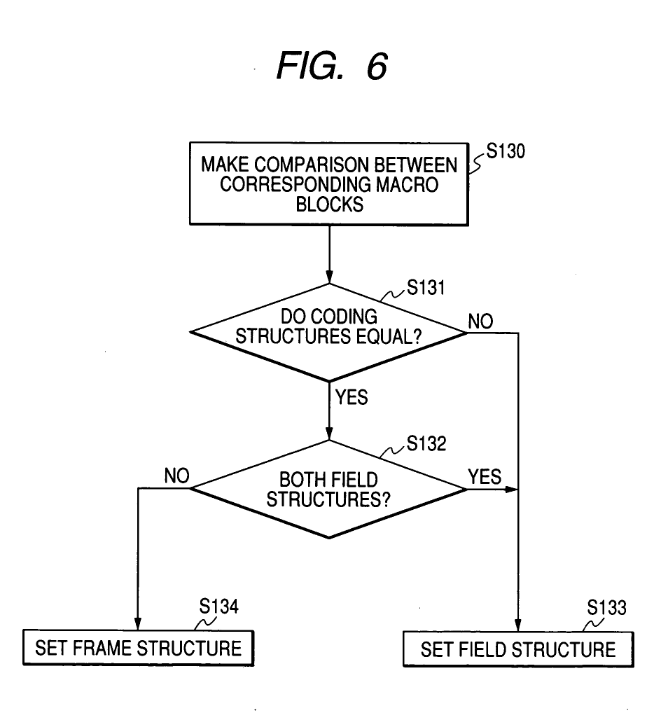

FIG. 6 shows a specific processing flow.

A comparison is made between the coding structures of the corresponding macro blocks (steps S130 and S131).

If the coding structures of the two macro blocks equal (YES at step S131), the coding structure is adopted intact as the coding structure of the macro block pair. That is, if the coding structures of both the macro blocks are field structures, the coding structure of the macro block pair is set to the field structure (step S133); if the coding structures are frame structures, the coding structure is set to the frame structure (step S134).

If the coding structure of one macro block is frame structure and that of the other is field structure (NO at step S131), the coding structure of the macro block pair is set to the field structure (step S133).

If the picture type of picture to be converted is intraframe coding, the coding mode of the macro block pair is set to intraframe coding, and coding parameter conversion processing is terminated. If the coding mode of the picture to be converted is interframe coding, the coding parameter set used for prediction coding is converted as follows:

S114: Convert Coding Parameters of Corresponding Macro Blocks in Conformity with Coding Structure of Macro Block Pair

The coding parameters of the macro blocks corresponding to the macro block pair are converted according to the coding system of the first video coded video sequence in conformity with the coding structure of the macro block pair.

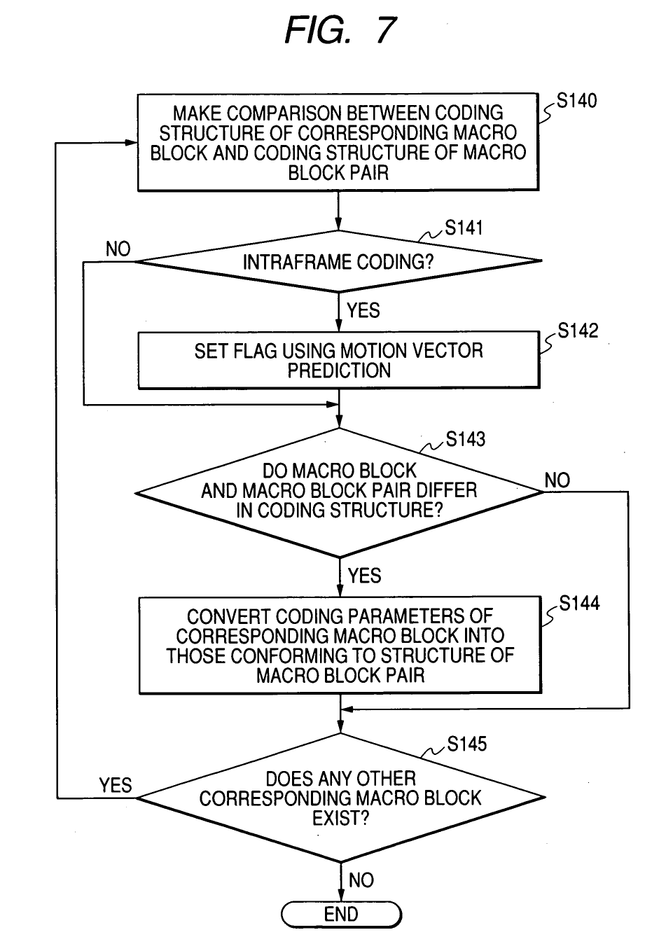

FIG. 7 shows a specific processing flow of conversion from intraframe coding to interframe coding. First, if the coding mode of each of the corresponding macro blocks is intraframe coding (YES at step S141), the coding mode is converted into the interframe coding mode and essentially non-existing motion vector and prediction type are also generated based on the coding structure of the macro block (step S142).

Specifically, when the DCT type of intraframe coding is field structure, the prediction type is set to field prediction; when the DCT type is frame structure, the prediction type is set to frame prediction. For motion vector, a flag is set so that the coding section generates a motion vector based on vector prediction. The reason why such processing is performed is that in the coding parameter conversion in the embodiment, if the picture type of picture to be converted is intraframe coding, the coding parameters output as the conversion result are all made those for interframe coding.

Next, a comparison is made between the coding structure of each of the corresponding macro blocks and the coding structure of the macro block pair to convert into (step S143). If the coding structures differ (YES at step S143), the coding structure, the motion vector, and the prediction type of the corresponding macro block are converted into those conforming to the structure of the macro block pair (step S144).

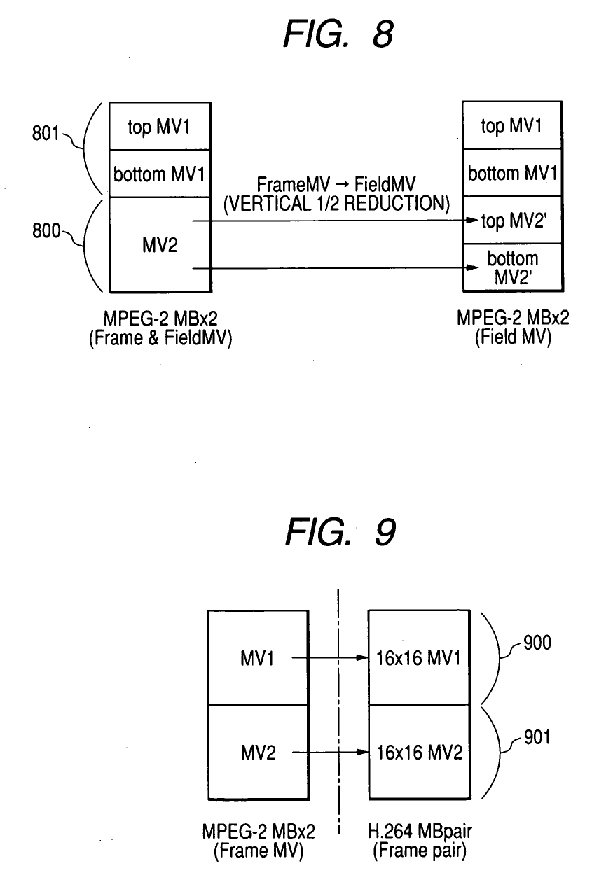

Specifically, if the coding structure of corresponding macro block 800 is frame structure and the coding structure of macro block pair 801 is field structure, the prediction type of the corresponding macro block 800 is converted into field prediction and the frame prediction motion vector is converted into field prediction motion vector, as shown in FIG. 8. At this time, the vertical component of frame prediction motion vector MV2 is halved to generate two field predictions MV2′ (top MV2′ and bottom MV2′) having the same value.

If the coding structure of the corresponding macro block is field structure and the coding structure of the macro block pair is frame structure, a frame prediction motion block is generated from the field prediction motion vector contained in the corresponding macro block. The conversion processing described above is repeated until the coding structures of the corresponding macro blocks all match the coding structure of the macro block pair (step S145).

If the coding structures of the corresponding macro blocks and the macro block pair are matched, last the motion vectors and the motion compensation block shapes are converted.

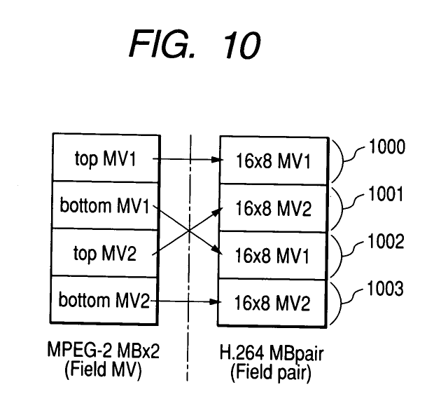

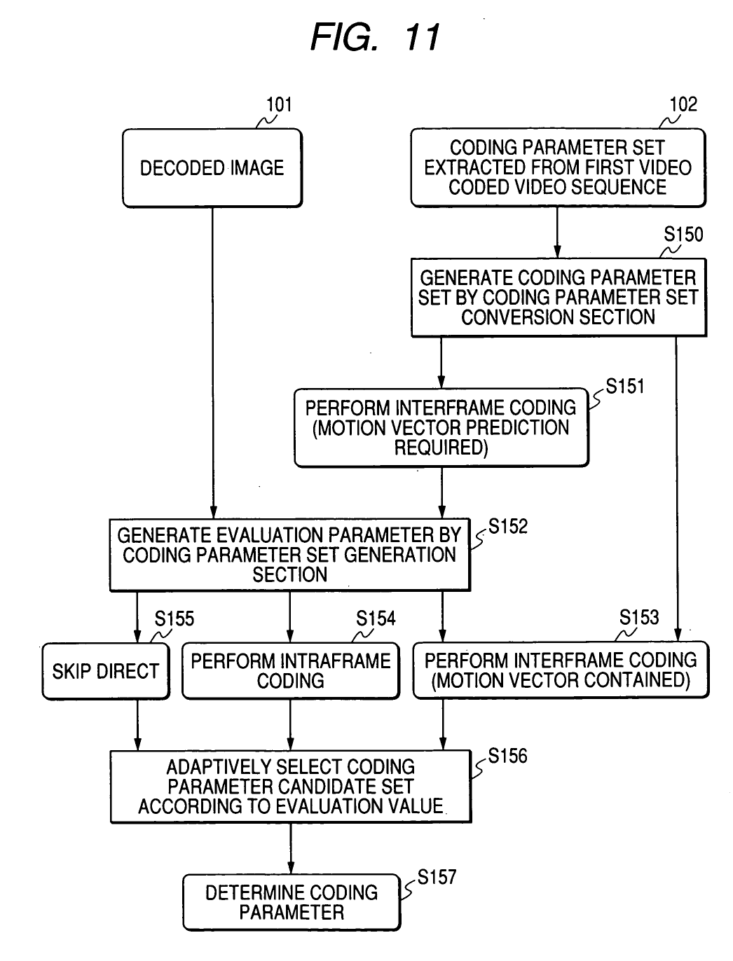

FIGS. 9 and 10 show specific conversion methods of coding format conversion.

FIG. 9 shows the shapes of motion compensation blocks 900 and 901 when the coding structure of the macro block pair is frame structure. If the coding structure of the macro block pair is frame structure, the upper and lower motion compensation block shapes are set to each 16×16 and the motion vectors are converted into those indicating the same reference position considering the pixel precision as frame prediction motion vectors, as shown in FIG. 9.

FIG. 10 shows the shapes of motion compensation blocks 1000, 1001, 1002, and 1003 and assignment of motion vectors when the coding structure of the macro block pair is field structure.

On the other hand, if the coding structure of the macro block pair is field structure, the motion compensation block shape is set to 16×8, as shown in FIG. 10. For the motion vectors, two motion vectors top MV1 and top MV2 involved in the top field are assigned to the upper macro block of the macro block pair, and two motion vectors bottom MV1 and bottom MV2 involved in the bottom field are assigned to the lower macro block of the macro block pair.

For the motion block shape, a parameter concerning any other block shape than the block shape set as mentioned above may be set.

For example, when the coding structure is field structure, a 16×16 block shape may be set from two 16×8 block shapes. In this case, one of the motion vectors for the two 16×8 block shapes is selected using the evaluation value of the residual signal size, etc.

In addition, two 16×8 block shapes may be generated from a 16×16 block shape. In this case, the motion vector for the 16×16 block shape may be assigned to both the two block shapes or use of motion vector prediction may be preset and the coding parameter generation section at the following stage may calculate motion vector.

The coding parameter set conversion section 111 generates the coding parameter set 105 for the second video coded video sequence from the coding parameter set 102 of the first video coded video sequence 100; the coding parameter set generation section 113 generates the coding parameter set for the second video coded video sequence using the decoded image 101 of the first video coded video sequence and the already coded second video coded video sequence 103.

For example, if the picture type of the first video coded video sequence is interframe coding, the coding parameter set section mainly generates the coding parameter set for interframe coding and thus the coding parameter set generation section generates intraframe coding parameter set, skip, and direct prediction data not generated by the coding parameter set conversion section.

For the interframe coding parameter set, the coding parameter set generation section performs motion vector prediction and generates a motion vector for the part where a flag is set for using a prediction motion vector in the coding parameter set conversion section.

FIG. 11 shows a processing flow of the coding parameter set selection section 112.

The coding parameter set selection section 112 acquires the coding parameter candidate sets 105 and 104 used for conversion from the coding parameter set conversion section 111 and the coding parameter set generation section 113. Specifically, the coding parameter set selection section 112 acquires the interframe prediction coding parameter set 105 generated by the coding parameter set conversion section 111 and the interframe prediction coding parameters and other coding parameters 104 generated by the coding parameter set generation section 113.

Coding efficiency is evaluated for coding parameter candidates. Specifically, if a motion vector is evaluated, SAD (sum of absolute differences), R-D (rate-distortion), etc., can be used.

Last, the coding parameter set for providing the best coding efficiency is selected as the parameter set used for actual coding.

The coding section codes the decoded image using the parameter set selected by the coding parameter set selection section 112, generates a second video coded video sequence, and outputs the second video coded video sequence.

Thus, the video coded video sequence conversion apparatus according to the first embodiment collectively sets the coding parameters as a set for the macro block pair based on the coding parameters of the corresponding macro blocks, so that the coding parameters can be reused efficiently while the limiting conditions on the coding parameters in the macro block pair are satisfied, and it is made possible to improve the coding efficiency and suppress image quality degradation.

### Second Embodiment

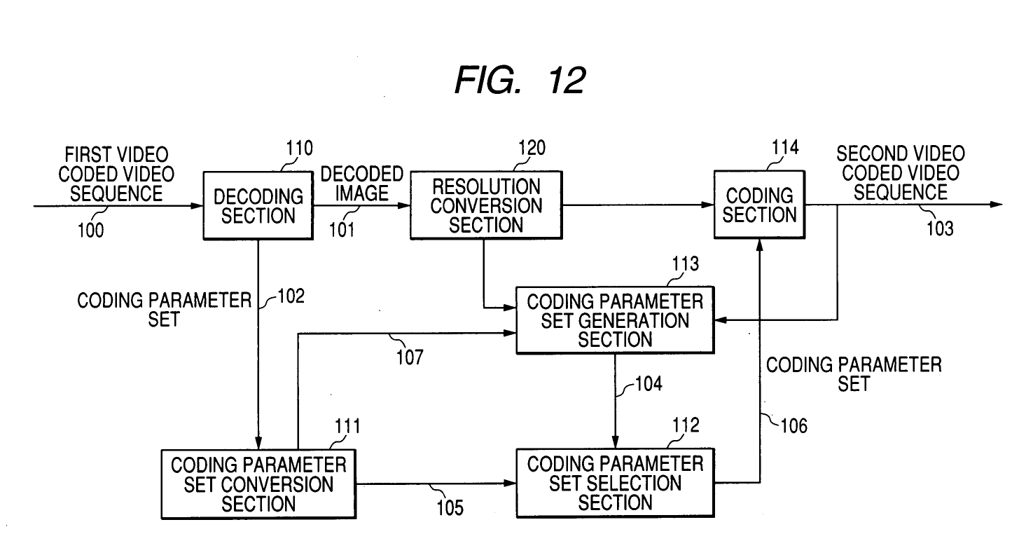

FIG. 12 is a block diagram to show a video coded video sequence conversion apparatus according to a second embodiment.

The video coded video sequence conversion apparatus according to the second embodiment differs from the video coded video sequence conversion apparatus according to the first embodiment previously described with reference to FIG. 1 in that a resolution conversion section 120 is placed following a decoding section 110 for converting the resolution of a decoded image 101 and then re-encoding the image.

In the second embodiment, it is assumed that the resolution conversion section 120 converts the resolution of an input image to a lower resolution.

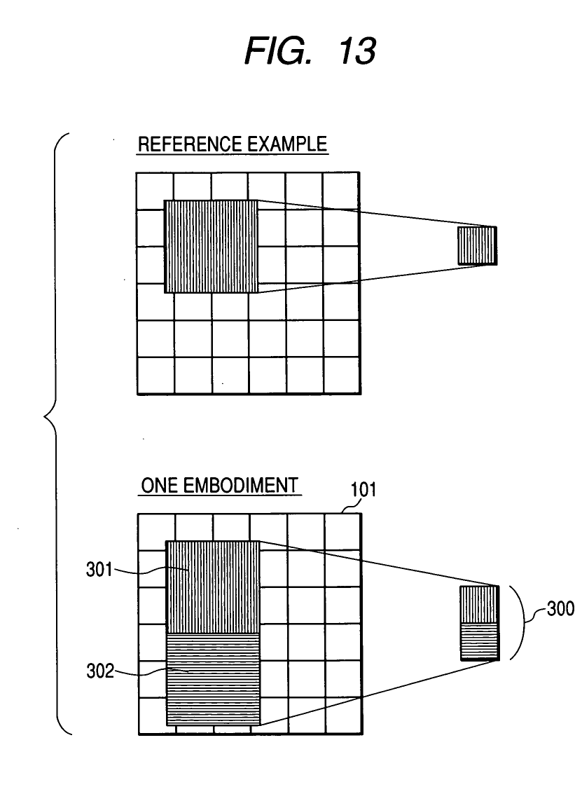

In a coding parameter set conversion section 111 in the second embodiment, the number of macro blocks corresponding to one macro block pair becomes more than two. FIG. 13 shows an example to specifically show the relationship between one macro block pair and the macro blocks corresponding thereto. In the example in FIG. 13, corresponding macro blocks 301 and 302 occupying 24 macro blocks of a decoded image 101 correspond to a macro block pair 300.

In order to positively select the field structure as the coding structure of the macro block pair, the coding parameter set selection section 112 may be configured to select the field structure as the coding structure of the macro block pair when at least one of the macro blocks having the field structure is included in the corresponding macro block (MNUM>0).

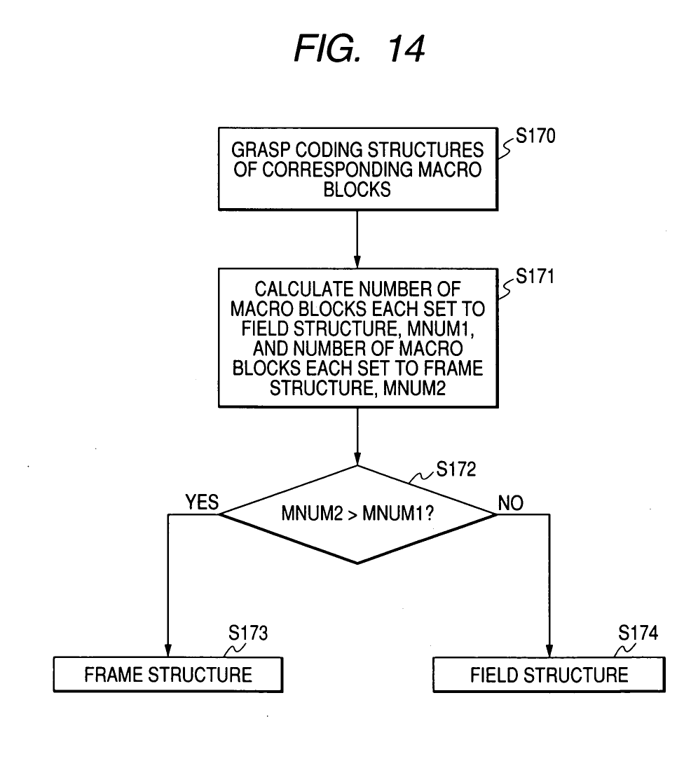

In the second embodiment, unlike the processing in FIG. 6 in the first embodiment, the coding structure of a macro block pair is determined based on the number of the coding structures of the corresponding macro blocks. FIG. 14 shows a specific processing flow.

First, a plurality of macro blocks of a first video coded video sequence corresponding to a macro block pair 300 of a second video coded video sequence (a plurality of corresponding macro blocks contained in the areas indicated by 301 and 302) as shown in FIG. 13 are extracted and the coding structures of the macro blocks are grasped (step S170).

Next, for the coding structures of the corresponding macro blocks, the number of the macro blocks each set to field structure, MNUM1, and the number of the macro blocks each set to frame structure, MNUM2, are calculated (step S171).

Next, the number of the macro blocks set to field structure MNUM1 and the number of the macro blocks set to frame structure MNUM2 are compared (step S172). And if the number of the macro blocks each set to frame structure, MNUM2, is greater than the number of the macro blocks each set to field structure, MNUM1, a second video coded video sequence is generated by re-encoding using the frame structure (step S173). If the number of the macro blocks each set to frame structure, MNUM2, is less than the number of the macro blocks each set to field structure, MNUM1, a second video coded video sequence is generated by re-encoding using the field structure (step S174).

If MNUM1 and MNUM2 equal, second video coded video sequence is generated by re-encoding using the field structure (step S174).

If MNUM1 and MNUM2 equal, the evaluation value based on the coding parameter set may be set for each macro block and the coding structure may be determined using the sum of the evaluation values of the coding structures. The code amount of each macro block, the product of the code amount and the quantization value, etc., is available as the evaluation value.

In the above, a technique is described in which the coding structure to be used for generating the second video coded video sequence is determined by simply comparing the number of the macro blocks set to field structure MNUM1 and the number of the macro blocks set to frame structure MNUM2.

However, a technique may be applied instead of the above, the technique in which performing: calculating a corresponding areas of the macro blocks having each of the coding structure and corresponding to the second video coded video sequence; setting an estimation value in accordance with a proportion of each of the corresponding areas; and determining the code structure of the macro block pair. The technique thus performed will be described in detail hereinbelow.

Herein, a situation is described in which an image conversion in horizontal (height) direction is performed.

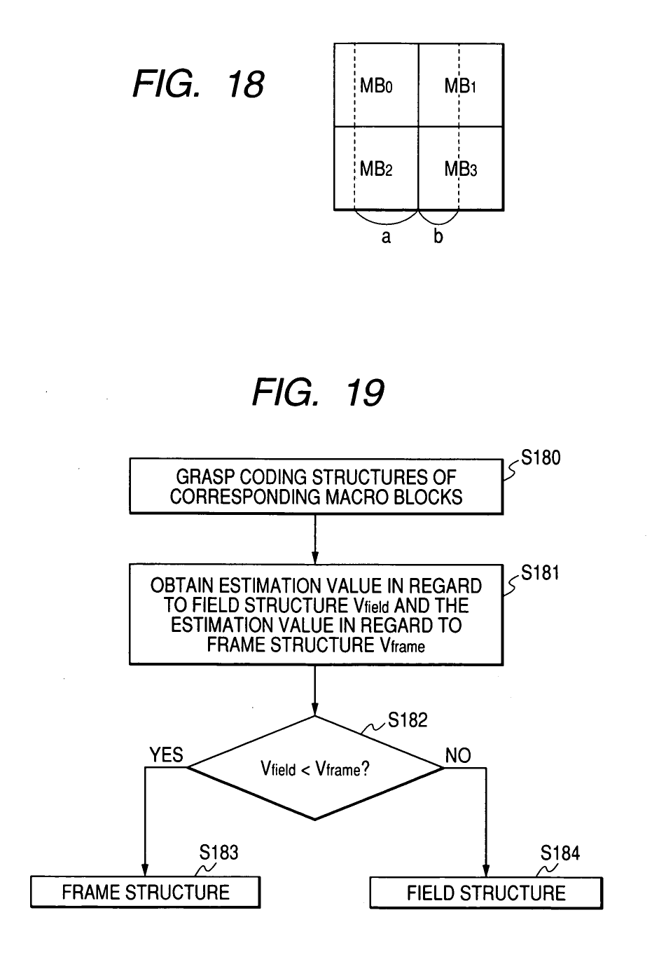

In the following description, four macro blocks correspond to one macro block pair in a:b proportion as shown in FIG. 18.

When performing the image conversion, an estimation value in regard to field structure V_{field} and an estimation value in regard to frame structure V_{frame} is obtained by the following equations (1) and (2). A ratio between the estimation values V_{field} and V_{frame} indicates a ratio between an area of the macro block having frame structure in the macro block pair and an area of the macro block having field structure in the macro block pair.
V_{field}=a·(T_{field}(MB₀)+T_{field}(MB₂))+b·(T_{field}(MB₁)+T_{field}(MB₃)) (1)
V_{frame}=a·(T_{frame}(MB₀)+T_{frame}(MB₂))+b·(T_{frame}(MB₁)+T_{frame}(MB₃)) (2)

In the equations (1) and (2), each of MB₀, MB₁, MB₂, MB₃ represents area of each of four macro blocks shown in FIG. 18. The T_{field} and T_{frame} in the equations (1) and (2) are functions that indicate whether the code structure of each of the macro blocks is the field structure or the frame structure, and are defined by the following equations (3) and (4).

$$\begin{matrix}{T}_{field} ( {MB}_{i} ) = \{ \begin{matrix}1 & if {MB}_{i} = fieldMB \\ 0 & else\end{matrix} & ( 3 ) \\ {T}_{frame} ( {MB}_{i} ) = \{ \begin{matrix}1 & if {MB}_{i} = frameMB \\ 0 & else\end{matrix} & ( 4 )\end{matrix}$$

The process for selecting code structure according to the technique is shown in FIG. 19.

First, as shown in FIG. 19, a plurality of macro blocks of a first video coded video sequence corresponding to a macro block pair of a second video coded video sequence are extracted and the coding structures of the macro blocks are grasped (step S180).

Next, the estimation value in regard to field structure V_{field} and the estimation value in regard to frame structure V_{frame} is obtained by the equations (1) and (2) (step S181).

Next, the values of V_{field} and V_{frame} obtained by the equations (1) and (2) are compared (step S182). And, in a case where V_{field}<V_{frame} stands, the second video coded video sequence is generated by re-encoding using the frame structure (step S183). In a case where V_{field}≧V_{frame} stands, the second video coded video sequence is generated by re-encoding using the field structure (step S184).

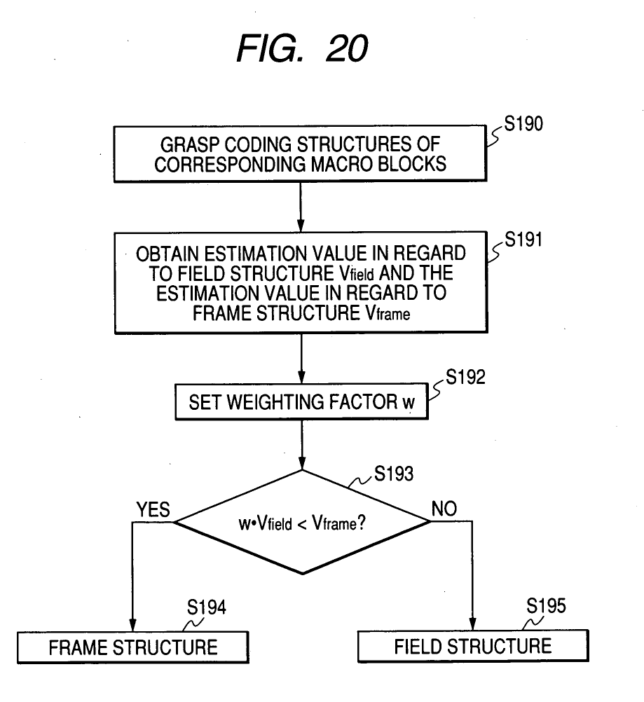

When determining which of the field structure and the frame structure is to be used, the value V_{field} may be weighted in order to select the use of field structure. The process for selecting code structure according to the technique is shown in FIG. 20.

First, as shown in FIG. 20, a plurality of macro blocks of a first video coded video sequence corresponding to a macro block pair of a second video coded video sequence are extracted and the coding structures of the macro blocks are grasped (step S190).

Next, the estimation value in regard to field structure V_{field} and the estimation value in regard to frame structure V_{frame} is obtained by the equations (1) and (2) (step S191).

Next, the value of the weighting factor “w” is set (step S192), and the values of V_{field} weighted by the factor “w” and V_{frame} are compared (step S193). And, in a case where W·V_{field}<V_{frame} stands, the second video coded video sequence is generated by re-encoding using the frame structure (step S194). In a case where w·V_{field}≧V_{frame} stands, the second video coded video sequence is generated by re-encoding using the field structure (step S195).

The weighted factor “w” is to be set for each of the video coded video sequence to be converted. The value of the weighted factor “w” may be set to be constant for each of the video coded video sequence, or may be adaptively varied within the video coded video sequence.

When adaptively varying the weighted factor “w”, there may be configured that the weighted factor “w” is determined based on a conversion proportion of the resolution of the image, or may be configured that the weighted factor “w” is determined based on a ratio between a bit rate of the first video coded video sequence and a bit rate of the second video coded video sequence. The value of the weighted factor “w” may be uniquely set in accordance with the conversion proportion of the resolution of the image for each of the video coded video sequence, or may be adaptively varied in accordance with information regarding the corresponding macro block (the information indicating, e.g., size, dispersion, and coding amount) and with information regarding picture (the information indicating, e.g., picture type and coding amount).

[Methods for Setting the Weighting Factor]

First Method: Use of Constant Value

Herein, a first method for setting the weighting factor “w” will be described.

In the first method, the weighting factor “w” is set to a constant value so that the field structure is selected when proportion of the macro block that corresponds to the macro block pair and has the field structure exceeds a predetermined proportion α (where 0≦α≦1). The weighting factor “w” is calculated by the following equation (5).
w=(1−α)/α (5)

When the weighting factor “w” obtained by the equation (5) is used, the field structure is selected when proportion of the macro block that corresponds to the macro block pair and has the field structure exceeds a predetermined proportion α.

Second Method: Use of Distance of the Motion Vector

Next, a second method for setting the weighting factor “w” will be described. In the second method, the weighting factor “w” is determined based on a difference between a motion vector corresponding to a top field and a motion vector corresponding to a bottom field, in the motion vector for field prediction.

Here, it is assumed that a macro block having field structure exists in a macro block corresponding to the macro block pair.

In a macro block of field prediction, there is included the motion vector corresponding to the top field and the motion vector corresponding to the bottom field. And, when a distance between the two motion vectors in the macro block is large, it is presumed that there is a large possibility that two fields each having phase different with each other exist in the corresponding macro block. Here, a Euclidean distance may be used to determine the distance between the two vectors.

Accordingly, the coding structure to be used may be determined suitably for the status of the first video coded video sequence in a format such as MPEG-2, by adaptively varying the weighting value “w” in accordance with the distance between the two motion vectors of field prediction included in the corresponding macro block.

In this case, it is preferable to calculate the difference between the two motion vectors for the macro blocks that form field structure of a whole picture, and to vary the weighting value “w” for each of picture units based on an amount of statistics of the calculation.

Third Method: Use of Bit Rate

Next, a third method for setting the weighting factor “w” will be described. In the third method, the weighting factor “w” is determined based on a bit rate.

When considering a frame prediction and a field prediction in MPEG-2, performing two of the field prediction by 16×8 block can achieve motion compensation that is achieved by performing the frame prediction by 16×16 block.

In doing so, the coding amount may increase due to the increase of the motion vectors. However, it is preferable to positively perform the field prediction in a case where the bit rate after the conversion is large enough to ignore the increase of the coding amount of the motion vector, because that the motion vector of the first video coded video sequence of MPEG-2 can be effectively used.

However, in a case where the bit rate after the conversion is small and the proportion in the bitstream of the coding amount in a header of the macro block is large, the coding amount of the motion vector may cause some effect to the whole image quality.

Therefore, the image quality can be improved by varying the weighting factor “w” for the field structure in accordance with a rate between a bit rate of the first video coded video sequence that is to be converted and a bit rate of the second video coded video sequence converted by the conversion.

The value of the weighting factor “w” may be uniquely set for a stream of the first video coded video sequence. For a stream having a variable bit rates, the weighting factor “w” may be variably set for each of GOP (Group of Picture) or be variably set in accordance with the coding amount for each of the pictures.

Fourth Method: Use of Activity

Next, a fourth method for setting the weighting factor “w” will be described. In the fourth method, the weighting factor “w” is determined based on an activity of the video coded video sequence.

Here, the “activity” is a numerical value indicating information amount of the video image to be encoded. In the video image conversion, the activity is calculated as follows.

The activity for each of the macro blocks is calculated by multiplying coding amount of the macro block and a step value of quantization. The activity for each of the picture units is calculated by multiplying an average step value of quantization of the picture and coding amount of the picture.

In the fourth method, the weighting factor “w” is variably set using the activity obtained by the above calculation. In doing so, the computed values of activities for each of the macro blocks of the field structure and the frame structure, is summed in accordance with the proportion of the areas as such described in the above for the evaluation values V_{field} and V_{frame}, and the weighting factor “w” is set in accordance with the proportion of the two values of activities.

There may be configured that, in a case where the evaluation values V_{field} and V_{frame} are close with each other, the coding structure of the macro block pair may be determined based on which of the activity of field structure and the activity of frame structure is large. The weighting factor “w” may be adaptively set for each of the picture units in accordance with the activity for each of the picture units.

The video coded video sequence conversion apparatus may be configured to perform any one of the methods for setting the weighting factor, or may be configured to perform the methods in combination.

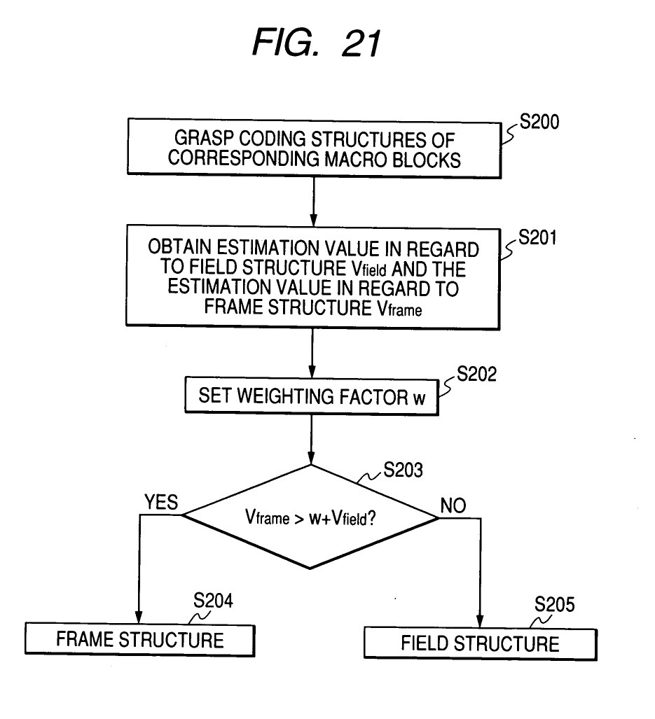

The weighting factor “w” may be added to the estimation value V_{field} as an offset value instead of linearly combining the weighting factor “w” and the estimation value V_{field} as described in the above. For example, there may be configured that the frame structure is selected when V_{frame}>w+V_{field} stands, and the field structure is selected when V_{frame}≦w+V_{field} stands. The process for selecting code structure according to the technique is shown in FIG. 21.

First, as shown in FIG. 21, a plurality of macro blocks of a first video coded video sequence corresponding to a macro block pair of a second video coded video sequence are extracted and the coding structures of the macro blocks are grasped (step S200).

Next, the estimation value in regard to field structure V_{field} and the estimation value in regard to frame structure V_{frame} is obtained by the equations (1) and (2) (step S201).

Next, the value of the weighting factor “w” is set (step S202), and the values of V_{field} weighted by the factor “w” and V_{frame} are compared (step S203). And, in a case where V_{frame}>W+V_{field} stands, the second video coded video sequence is generated by re-encoding using the frame structure (step S204). In a case where V_{frame}≦w+V_{field} stands, the second video coded video sequence is generated by re-encoding using the field structure (step S205). The value of the weighted factor “w” may be set to be constant for each of the video coded video sequence, or may be adaptively varied within the video coded video sequence, as described in detail in the above.

In the above, there is described of a case where an image resolution is converted in a horizontal (width) direction and where the four macro blocks correspond to one macro block pair, as shown in FIG. 18. However, in a case where the image resolution is converted in a vertical (height) direction or in both the horizontal and vertical direction, and in a case where more than four macro blocks correspond to one macro block pair, the code structure to be used in generating the second video coded video sequence may be determined by obtaining correspondence proportion of each of the macro blocks having the frame and the field structure, and by expanding the equations (1) and (2) in accordance with the correspondence proportion.

Next, conversion of motion vector is explained.

When a motion vector is converted, a plurality of motion vector candidates exist in conversion involving resolution conversion and thus which motion vector is suited is determined using an evaluation value for selecting the optimum motion vector.

For example, the prediction residual code amount of each macro block, the quantization value, the motion vector size, the product of the prediction residual and the code amount can be used as the evaluation value.

The motion vector is scaled in conformity with the resolution conversion ratio. When the motion vector is scaled, fraction processing is performed with the precision supported by the coding system of the second video coded video sequence. Specifically, the value is found with ¼ pixel precision at the scaling time because the motion vector precision is ¼ pixel precision in H.264 although it is ½ pixel precision in MPEG-2.

In the second embodiment, unlike the first embodiment, the motion compensation block shape cannot be converted in a one-to-one correspondence in some cases. Since the macro block size of the first video coded video sequence corresponding to the macro block pair becomes relatively small accompanying resolution conversion, if the block shape of any one of the corresponding macro blocks is used, the block shape becomes too small and a situation in which the coding efficiency is degraded can occur.

Then, the motion compensation block shape is previously determined based on the coding structure of the macro block pair. Specifically, if the frame structure is applied, 16×16 block shape is used and if the field structure is applied, 16×8 block shape is used.

The number of generated block shapes is not limited to one as with the first embodiment. For example, the 16×8 block shape may be generated with the frame structure or the 16×16 block shape may be generated with the field structure.

In the final conversion, parameters are generated as shown in FIG. 2 in conformity with the macro block pair structure for each of the corresponding macro blocks and are converted into the coding parameter set for the second video coded video sequence as with the first embodiment.

Processing of a decoding section, a coding parameter selection section, and a coding section is performed as in the first embodiment.

Thus, the video coded video sequence conversion apparatus according to the second embodiment collectively sets the coding parameters as a set for the macro block pair based on the coding parameters of the corresponding macro blocks also in the conversion involving the resolution conversion, so that the coding parameters can be reused efficiently while the limiting conditions on the coding parameters in the macro block pair are satisfied, and it can be expected that the code amount will be furthermore decreased.

### Third Embodiment

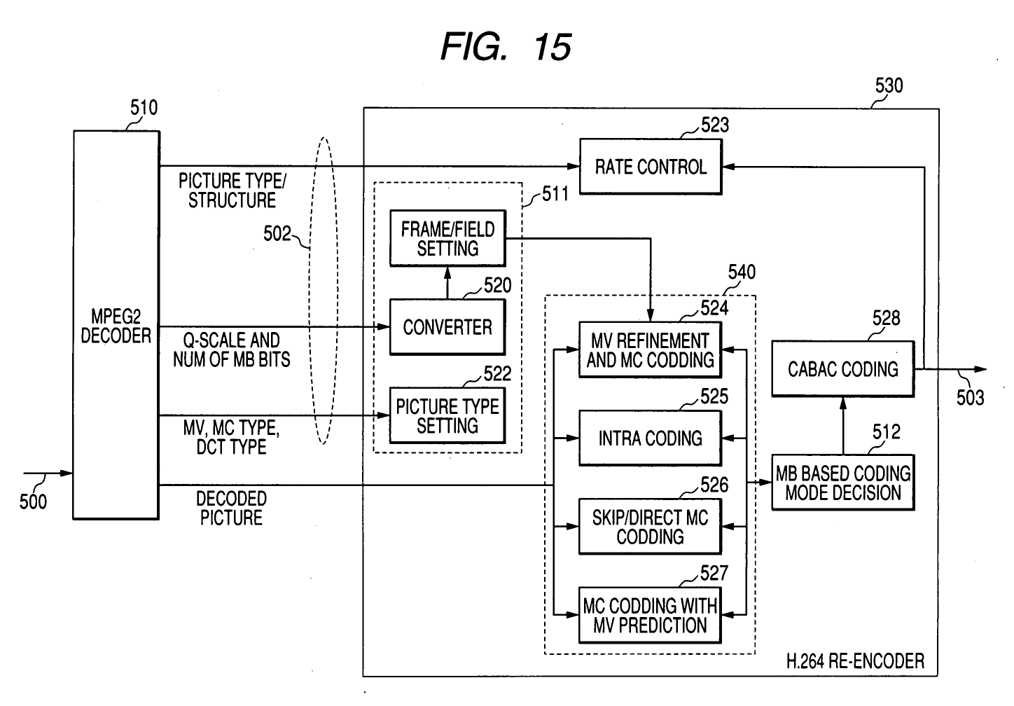

The configuration and the operation of a video coded video sequence conversion apparatus according to a third embodiment will be discussed with FIGS. 15 to 17. FIG. 15 is a block diagram to show the video coded video sequence conversion apparatus according to the third embodiment.

In the video coded video sequence conversion apparatus according to the third embodiment, a first video coded video sequence 500 coded in MPEG2 is input and a second video coded video sequence 503 again coded in H.264 is output.

An MPEG2 decoder 510 decodes the first video coded video sequence 500 and outputs a decode image 501 and also outputs a coding parameter set for each coded picture (upper stage of 502), of the picture type (any of I picture, P picture, or B picture), a flag indicating whether the code sequence is coding of only a progressive image (progressive sequence) or coded data containing an interlace image, the picture structure (progressive frame picture, interlace frame picture, field picture), etc. A picture type setting section 522 determines the coding structure at the picture level at the H.264 recoding time.

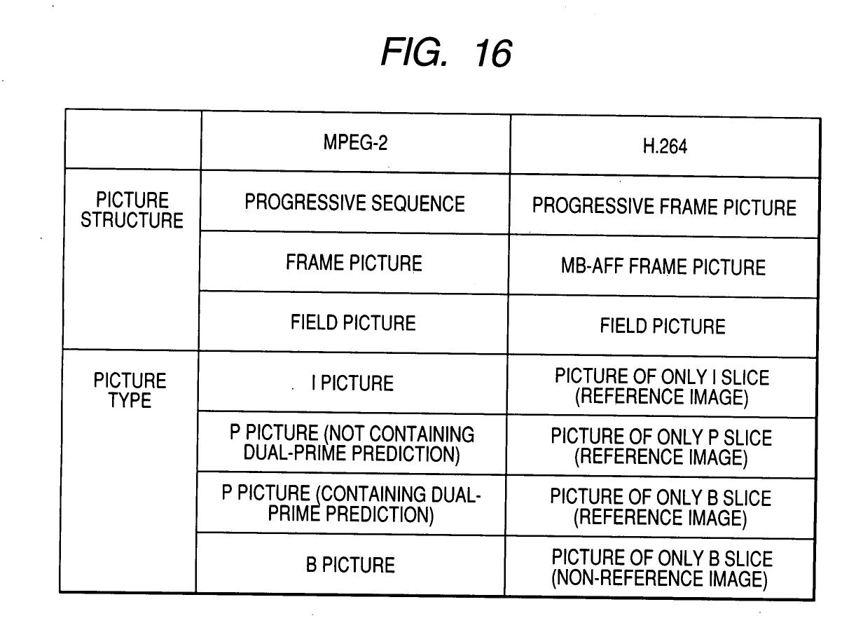

FIG. 16 shows an operation example of the picture type setting section 522 according to the third embodiment. If MPEG2 coded data is coded as the progressive sequence, the corresponding each frame is again coded as a progressive frame picture in H.264.

If MPEG2 coded data is not a progressive sequence, MPEG2 frame picture is again coded as an H.264 MB-AFF frame picture and MPEG2 field picture is again coded as an H.264 field picture. The picture whose coded picture type in MPEG2 is I picture is again coded as a reference picture formed of only I slice in H.264 and the picture whose coded picture type in MPEG2 is B picture is again coded as a non-reference picture formed of only B slice in H.264.

Further, if an MPEG2 P picture contains dual-prime prediction stipulated in MPEG2 (mode of cutting out prediction image blocks from reference picture of two forward fields and performing interpicture prediction coding with the average value as a prediction image), the MPEG2 P picture is again coded as a reference picture formed of only B slice in H.264.

If an MPEG2 P picture does not contain dual-prime prediction, it is again coded as a reference picture formed of only P slice in H.264. The picture level correspondence as described above is provided, whereby it becomes easy to provide the correspondence between the interframe prediction structure in macro block units in MPEG2 and that in H.264, reusability of the motion vector, the prediction mode, etc., in macro block units improves, and it is made possible to drastically reduce the computation cost at the H.264 recoding time (computation amount or hardware cost).

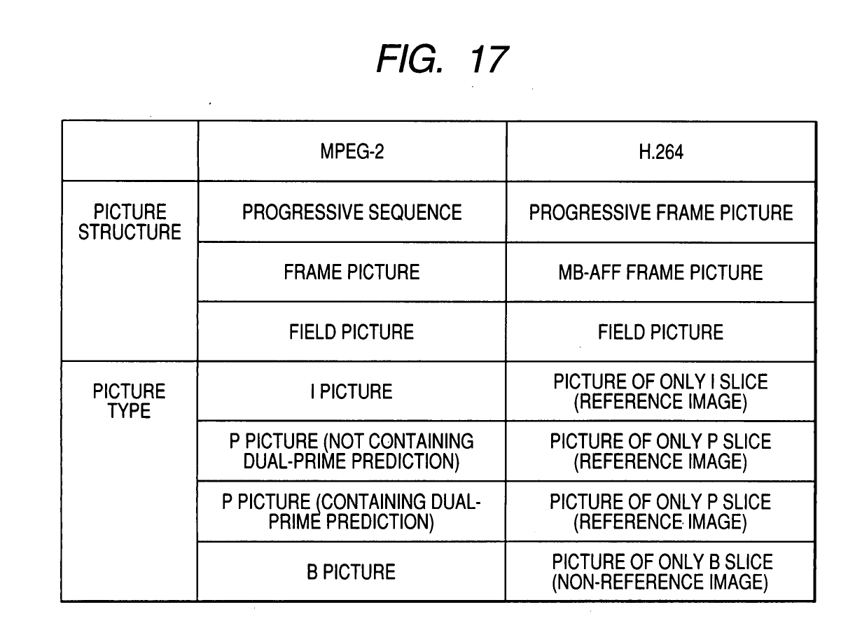

FIG. 17 shows another example of the picture type setting section 522. The example in FIG. 17 differs from that in FIG. 16 in that each MPEG2 P picture is again coded as a reference picture formed of only P slice in H.264 regardless of whether or not the MPEG2 P picture contains dual-prime prediction. In the MPEG2 P picture, dual-prime prediction can be used only if no B picture is contained in the playback order between the P picture and its reference picture and whether or not the MPEG2 P picture contains dual-prime prediction cannot be determined unless the prediction modes of all macro blocks in the picture are checked.

Therefore, in recoding from MPEG2 to H.264, a delay of at least one frame is required, resulting in an increase in buffer memory required for the delay and a time lag accompanying the recoding.

On the other hand, the dual-prime prediction is to conduct average prediction of the past two fields and thus it becomes impossible to conduct similar interpicture prediction in H.264 P slice. If all P pictures in MPEG2 are again coded as H.264 B slices, overhead of coded data indicating the prediction mode in prediction block units of the H.264 B slices, etc., increases, resulting in degradation of the coding efficiency.

To solve these problems, in the macro block using dual-prime prediction in MPEG2, single prediction using only the reference field near in time to the picture to be coded, of the reference picture of the past two fields is adopted and recoding is performed in H.264, whereby it is made possible to recode all macro blocks of MPEG2 P picture in H.264 P slice reusing motion vector information. Accordingly, both the problem of the delay at the recoding time and the problem of the reusability of the prediction structure can be solved, an increase in the computation cost at the H.264 recoding time can be suppressed, and further it is also made possible to prevent degradation of the coding efficiency in the recoding.

Next, the operation of the video coded video sequence conversion apparatus in FIG. 15 in the macro block units will be discussed.

The quantization scale value and the code amount in the macro block units (middle stage of 502) are extracted from the coding parameter set in the macro block units in the first video coded video sequence 500 and are input to a rate control section 523 and the generated code amount in the macro block units in H.264 recoding is also fed back into the rate control section 523 and is used to control the code amount at the H.264 recoding time.

To control the code amount at the recoding time, inputting the code information in the first video coded video sequence 500 is not indispensable; however, using the information of the MPEG2 code data, it is made possible to previously keep track of the coding characteristic in the macro: block units and realize efficient rate control with less image quality degradation.

Information of the motion vector, the motion compensation mode defined in the MPEG2 standard (frame prediction, field prediction, dual-prime prediction, etc.,), the DCT type (frame DTC or field DCT), etc., is extracted from the coding parameter set in the macro block units in the first video coded video sequence 500 and is input to a coding parameter conversion section 520. If the coding parameters are directly compatible with H.264, they are reused intact at the recoding time.

For example, if coding as a progressive sequence is performed in MPEG2, the motion compensation block size in H.264 is set to 16×16 pixels, whereby the MPEG2 motion vector can be used intact.

If coding as a field picture is performed in MPEG2, the motion vector can be used intact with the 16×16 field prediction mode in MPEG2 as 16×16 prediction in H.264 and the 16×8 field prediction mode in MPEG2 also as 16×8 interpicture prediction in H.264.

For dual-prime prediction in MPEG2, to recode as B slice in H.264 as described above, the motion vector can be reused intact; to recode as P slice in H.264, single prediction only from the reference field near to the picture to be coded is adopted, whereby it is made possible to reuse the motion vector.

If the MPEG2 coding parameter is not directly compatible with H.264 in the MB-AFF pair type, etc., the coding parameter conversion section 520 appropriately converts the MPEG2 coding parameter as previously described in the first or second embodiment, and further whether the coding structure in the macro block pair units at the H.264 recoding time is frame structure or field structure is set in a frame/field setting section 521 for reuse in H.264 recoding.

More specifically, the I picture in MPEG2 is again coded as a picture formed of only I slice in H.264 and if frame DTC and field DCT mix in the I picture in MPEG2, recoding is performed as an MB-AFF frame.

If an MPEG2 macro block set corresponding to an H.264 macro block pair is coded as the same DTC type, the macro block pair type (frame pair or field pair) is determined according to the type. If frame DTC and field DCT mix, the macro block pair type is determined frame pair.

According to the determined macro block pair type, an intra prediction coding section 525 selects the optimum prediction mode set from among intra prediction modes (Intra 4×4 prediction (a maximum of nine modes), Intra 8×8 prediction (a maximum of nine modes), Intra 16×16 prediction (a maximum of four modes) for each macro block and performs recoding.

The optimum prediction mode can be determined by determination using the evaluation value of the sum of absolute differences of prediction error signals, or mode determination based on a rate distortion optimization technique using the generated code amount or its estimation value and coding distortion or its estimation value in each mode.

The MB-AFF pair type is previously determined only from the MPEG2 code information as described above, whereby processing of again determining the optimum pair type in H.2564 recoding becomes unnecessary and it is made possible to drastically reduce the computation cost at the recoding time (computation amount or hardware cost).

For the P picture or B picture in MPEG2, for the macro block wherein interpicture prediction coding is used, a motion vector re-search section 524 again searches for a motion vector in a minute area, as required, centering on motion vectors extracted from MPEG2 code data and appropriately converted as required.

In MPEG2, usually a motion vector with ½ pixel precision is used; in H.264, usually a motion vector with ¼ pixel precision is used. Therefore, in the embodiment, the motion vector re-search section again searches for a motion vector at least in the proximity of the search center ±0.25.

To enhance the coding efficiency at the recoding time, the search center with ½ pixel precision is rounded to an integer pixel position and a search is made in the range of the proximity of the search center ±1.75, whereby it is made possible to determine a more appropriate motion vector.

Since a compensation filter for decimal pixel position prediction in MPEG2 and a decimal pixel compensation filter differ in characteristic, the search center obtained from the motion vector with ½ pixel precision in MPEG2 is not necessarily the optimum position. The motion vector search center rounded to an integer pixel position has an error of ±one pixel relative to the optimum value of a motion vector with integer precision and further the effect of the compensation filter fluctuates in the range of ±0.75 pixels and therefore a search is made in the range of ±1.75 pixels from the search center rounded to an integer pixel position, whereby it is made possible to find a proper motion vector. Accordingly, it is made possible to detect a motion vector for H.264 recoding giving high coding efficiency in re-search in a minute area of ±1.75 pixels, and both a reduction in the recoding cost and improvement of the coding efficiency are made possible at the same time.

Further, the motion vector research result is provided and the intra prediction coding section 525 selects the optimum prediction mode set from among intra prediction modes (Intra 4×4 prediction (a maximum of nine modes), Intra 8×8 prediction (a maximum of nine modes), Intra 16×16 prediction (a maximum of four modes) for each macro block and a Skip/Direct coding section 526 performs prediction coding in H.264 interpicture prediction mode for providing high coding efficiency without the need for coding any motion vector, namely, P_Skip mode in H.264 in P slice or direct mode in H.264 in B slice. From among them, a macro block coding mode determination section 512 selects the coding mode for providing the highest coding efficiency for each macro block.

For the intra coding macro block in the P picture or B picture in MPEG2, an interpicture prediction section 527 performs prediction coding using the prediction vector in motion vector prediction coding stipulated in H.264 or the motion vector found by re-searching with the prediction vector as the search center. The output is used as an interpicture coding mode candidate.

According to the described configuration, the optimum mode is selected from among intra coding in H.264 providing high coding efficiency having a large number of prediction modes, P_Skip or direct prediction of interpicture prediction providing high coding efficiency, and the motion vector re-search result in the proper range using MPEG2 motion vectors regardless of whether the macro block coding mode is intra coding or interpicture prediction coding in the P picture or B picture in MPEG2, whereby it is made possible to drastically improve the coding efficiency at the recoding time while suppressing the computation cost.

To reduce the processing cost of coding mode determination, when the optimum mode is selected from among the H.264 intra prediction modes or at the motion vector re-searching time, mode determination is made according to the evaluation value with small computation amount such as the sum of absolute differences of prediction residual signals, etc., and at the mode determination time at the macro block level at the final stage, highly accurate mode determination is made according to the evaluation value of the rate-distortion optimization cost based on the generated code amount and coding distortion or the coding cost based on the estimated generated code amount and estimated coding distortion, whereby it is made possible to select the preferred coding mode and improve the coding efficiency while suppressing an increase in the computation amount.

Last, an H.264 CABAC (Context Adaptive Binary Arithmetic Coding) coding section 528 generates an H.264 bitstream using the selected coding mode.

The video coded video sequence conversion apparatus can also be implemented by using a general-purpose computer as the basic hardware, for example.

That is, the decoding section, the coding parameter conversion section, the coding parameter selection section, and the coding section can be implemented as a processor installed in the computer is caused to execute a program. At this time, the video coded video sequence conversion apparatus may be implemented as the program is previously installed in the computer or may be implemented as the program is stored on a record medium such as a CD-ROM or is distributed through a network and is installed in the computer whenever necessary. The decoding section, the coding parameter conversion section, the coding parameter selection section, and the coding section can be implemented appropriately using memory, a hard disk, or any other record medium such as a CD-R, a CD-RW, a DVD-RAM, or a DVD-R installed inside or outside the computer.

It is to be understood that the invention is not limited to the specific embodiment described above and that the invention can be embodied with the components modified without departing from the spirit and scope of the invention. The invention can be embodied in various forms according to appropriate combinations of the components disclosed in the embodiment described above. For example, some components may be deleted from all components shown in the embodiment. Further, the components in different embodiments may be used appropriately in combination.

A video coded video sequence conversion method and program according to one aspect of the invention can be described as those having any of the following illustrated structures or features:

(1) A coded video sequence conversion apparatus for converting a first bitstream provided by performing compression coding of a video signal of interlaced scanning in macro block units into a second bitstream based on a coding system subjected to compression coding in macro block units, the coded video sequence conversion apparatus including:

a decoding section that decodes a first code sting to provide a decoded image and a first coding parameter set;

a coding parameter set conversion section that converts, for each of pairs of macro blocks concerning the second bitstream adjacent to each other in a vertical direction on the decoded image, the first coding parameter set of each of corresponding macro blocks concerning the first bitstream corresponding to each pair on the decoded image to find a conversion coding parameter set;

a coding parameter set selection section that selects the conversion coding parameter set found relative to the pair as a second coding parameter set of each of the macro blocks of the pair; and

a coding section that performs compression coding of the decoded image using the second coding parameter set selected by said coding parameter set selection section to generate the second bitstream.

(2) The coded video sequence conversion apparatus according to (1) further including a coding parameter set generation section that generates a coding parameter candidate set using the decoded image or the already generated second bitstream,

wherein the coding parameter set selection section selects the second coding parameter set of each of the macro blocks of the pair from among the coding parameter candidate sets and the conversion coding parameter sets.

(3) The coded video sequence conversion apparatus according to (1), wherein the first coding parameter set contains at least one of:
coding structure information indicating which of a field structure and a frame structure the coding structure of the macro block is;
prediction type information indicating the prediction type of the macro block; and
DCT type information indicating the DCT type of the macro block,

Wherein the second coding parameter set and the conversion coding parameter set contain DCT type information indicating the DCT type of the macro block, and

wherein the coding parameter set conversion section sets the coding structure information of the conversion coding parameter set based on at least one of:
coding structure information of the corresponding macro block;
prediction type information of the corresponding macro block; and
DCT type information of the corresponding macro block.

(4) The coded video sequence conversion apparatus according to (3), wherein the coding parameter set conversion section includes:

an extraction section that extracts the coding structure information of the first coding parameter set of each of the corresponding macro blocks corresponding to each pair;

a comparison section that compares between the number of the corresponding macro blocks each having the value indicating a field structure and the number of the corresponding macro blocks each having the value indicating a frame structure about the coding structure information of each pair extracted by the extraction section; and

a setting section that sets the value indicating the field structure in the coding structure information of each macro block of the pair when the numbers equal as the comparison result of the comparison section, sets the value indicating the field structure in the coding structure information of each macro block of the pair when the number of the corresponding macro blocks each having the value indicating a field structure is larger than the number of the corresponding macro blocks each having the value indicating a frame structure, and sets the value indicating the frame structure in the coding structure information of each macro block of the pair when the number of the corresponding macro blocks each having the value indicating a frame structure is larger than the number of the corresponding macro blocks each having the value indicating a field structure.

(5) The coded video sequence conversion apparatus according to (3), wherein the coding parameter set conversion section includes:

an extraction section that extracts the coding structure information of the first coding parameter set of each of the corresponding macro blocks corresponding to each pair;

a determination section that determines whether or not the corresponding macro blocks each having the value indicating a field structure exist about the coding structure information of each pair extracted by the extraction section; and

a setting section that sets the value indicating the field structure in the coding structure information of each macro block of the pair when the corresponding macro blocks having the value indicating the field structure exists, and sets the value indicating the frame structure in the coding structure information of each macro block of the pair when all of the corresponding macro blocks have the value indicating the frame structure.

(6) The coded video sequence conversion apparatus according to (3), wherein the coding parameter set conversion section includes:

an extraction section that extracts the coding structure information of the first coding parameter set of each of the corresponding macro blocks corresponding to each pair;

an evaluation value calculation section that classifies the corresponding macro blocks corresponding to each pair according to the value of the coding structure information of the first coding parameter set and finding the evaluation value for each class using the first coding parameter set of the corresponding macro block belong to the class; and

a setting section that sets the coding structure information of each macro block of each pair in response to the evaluation value.

(7) The coded video sequence conversion apparatus according to (6), wherein the coding parameter set conversion section further includes a comparison section that compares between the number of the corresponding macro blocks each having the value indicating a field structure and the number of the corresponding macro blocks each having the value indicating a frame structure about the coding structure information of each pair extracted by the extraction section,

wherein the setting section of the coding parameter set conversion section sets the value indicating the field structure in the coding structure information of each macro block of the pair wherein the numbers equal as the comparison result of the comparison section and sets the value indicating the coding structure of the macro block of the higher evaluation value in the coding structure information of each macro block of the pair wherein the numbers differ.

(8) The coded video sequence conversion apparatus according to (6), wherein the evaluation value calculation section in the coding parameter set conversion section performs:

calculating corresponding areas of the macro blocks having the field structure and the frame structure and corresponding to the second video coded video sequence; and

calculating evaluation values for each of the macro blocks having the field structure and the frame structure in accordance with the calculated corresponding areas.

(9) The coded video sequence conversion apparatus according to (6), wherein the setting section of the coding parameter set conversion section sets the value indicating the field structure in the coding structure information of each macro block of the pair when the evaluation value of the corresponding macro block having field structure is not less than the evaluation value of the corresponding macro block having frame structure, and otherwise sets the value indicating the frame structure in the coding structure information of each macro block of the pair.

(10) The coded video sequence conversion apparatus according to (6), wherein the setting section of the coding parameter set conversion section sets the value indicating the field structure in the coding structure information of each macro block of the pair when a value obtained by adjusting the evaluation value of the corresponding macro block having field structure with a predetermined weighting factor is not less than the evaluation value of the corresponding macro block having frame structure, and otherwise sets the value indicating the frame structure in the coding structure information of each macro block of the pair.

(11) The coded video sequence conversion apparatus according to (10), wherein the setting section of the coding parameter set conversion section adjusts the weighting value uniquely or adaptively in accordance with coding information included in the first bitstream to be converted and coding information for the converted bitstream.

(12) The coded video sequence conversion apparatus according to (1), wherein the first coding parameter set, the second coding parameter set, and the conversion coding parameter set contain each coding structure information indicating which of a field structure and a frame structure the coding structure of the macro block is,

wherein the coding parameter set conversion section comprises:

a coding structure information comparison section that compares between the coding structure information of each macro block of the pair and the coding structure information of each of the corresponding macro blocks; and

a coding structure information conversion section that converts the first coding parameter set contained in the corresponding macro block relative to the pair wherein the coding structure information differs in conformity with the coding structure of each macro block of the pair.

(13) The coded video sequence conversion apparatus according to (12), wherein the coding structure information conversion section executes conversion so as to scale a motion vector contained in the corresponding macro block relative to the pair wherein the coding structure information differs in conformity with a time base.

(14) The coded video sequence conversion apparatus according to (2), wherein the coding parameter set generation section generates a coding parameter candidate set containing:

information concerning intraframe coding;

information concerning macro block skip; and

information concerning direct prediction coding.

(15) The coded video sequence conversion apparatus according to (2), wherein the first coding parameter set contains prediction type information indicating each of the corresponding macro blocks is interframe-coded or intraframe-coded in the first bitstream, and

wherein the coding parameter set generation section includes:

a calculation unit that calculates the motion vector prediction value for the macro block from motion vector information of the macro block in the second bitstream already subjected to compression coding in the surroundings of the macro block of the second bitstream about the intraframe-coded macro block of the corresponding macro blocks; and

a setting unit that sets the calculated motion vector prediction value about the intraframe-coded macro block of the corresponding macro blocks as a coding parameter candidate of the macro block.

(16) The coded video sequence conversion apparatus according to (2), wherein the coding parameter set selection section selects a coding parameter set based on the sum of absolute differences of prediction error signals generated using the coding parameter candidate set and the conversion coding parameter set.

(17) The coded video sequence conversion apparatus according to (2), wherein the coding parameter set selection section selects a coding parameter set based on rate distortion characteristic when compression coding is performed using the coding parameter candidate set and the conversion coding parameter set.

(18) The coded video sequence conversion apparatus according to (2), wherein the coding parameter set selection section selects a coding parameter set based on the generated code amount when compression coding is performed using the coding parameter candidate set and the conversion coding parameter set.

(19) The coded video sequence conversion apparatus according to (1) further including a resolution conversion section that converts resolution of an image included in the first bitstream.

(20) A coded video sequence conversion method for converting a first bitstream provided by performing compression coding of a video signal of interlaced scanning in macro block units into a second bitstream based on a coding system subjected to compression coding in macro block units, the method including:

a decoding step of decoding the first code sting to provide a decoded image and a first coding parameter set;

a coding parameter set conversion step of converting, as for a pair of macro blocks of the second bitstream adjacent to each other in a vertical direction on the decoded image, the first coding parameter set of each of corresponding macro blocks of the first bitstream corresponding to the pair on the decoded image to find a conversion coding parameter set;

a coding parameter set selection step of selecting the conversion coding parameter set found relative to the pair as a second coding parameter set of each of the macro blocks of the pair; and

a coding step of performing compression coding of the decoded image using the second coding parameter set selected in said coding parameter set selection step to generate the second bitstream.

(21) The coded video sequence conversion method according to (20) further including a coding parameter set generation step of generating a coding parameter candidate set using the decoded image or the already generated second bitstream,

wherein, in the coding parameter set selection step, the second coding parameter set of each of the macro blocks of the pair from among the coding parameter candidate sets and the conversion coding parameter sets, is selected.

(22) A computer-readable program product for causing a computer system to execute processing of converting a first bitstream provided by performing compression coding of a video signal of interlaced scanning in macro block units into a second bitstream based on a coding system subjected to compression coding in macro block units, the program product for causing the computer system to execute process including:

a decoding step of decoding the first code sting to provide a decoded image and a first coding parameter set;

a coding parameter set conversion step of converting, as for a pair of macro blocks of the second bitstream adjacent to each other in a vertical direction on the decoded image, the first coding parameter set of each of corresponding macro blocks of the first bitstream corresponding to the pair on the decoded image to find a conversion coding parameter set;

a coding parameter set selection step of selecting the conversion coding parameter set found relative to the pair as a second coding parameter set of each of the macro blocks of the pair; and

a coding step of performing compression coding of the decoded image using the second coding parameter set selected in said coding parameter set selection step to generate the second bitstream.

(23) The program product according to claim (22), further causes the computer system to execute process including a coding parameter set generation step of generating a coding parameter candidate set using the decoded image or the already generated second bitstream,

wherein, in the coding parameter set selection step, the second coding parameter set of each of the macro blocks of the pair from among the coding parameter candidate sets and the conversion coding parameter sets, is selected.

As described above with reference to the embodiments, according to the invention, the coding parameters are set collectively as a set for the macro block pair in the second video coded video sequence based on the coding parameter sets of the corresponding macro blocks in the first video coded video sequence, whereby the coding parameters can be reused efficiently while the limiting conditions on the coding parameters in the macro block pair are satisfied, and it is made possible to improve the coding efficiency and suppress image quality degradation.

The foregoing description of the embodiments has been presented for purposes of illustration and description. It is not intended to be exhaustive or to limit the invention to the precise form disclosed, and modifications and variations are possible in light of the above teachings or may be acquired from practice of the invention. The embodiment is chosen and described in order to explain the principles of the invention and its practical application program to enable one skilled in the art to utilize the invention in various embodiments and with various modifications as are suited to the particular use contemplated. It is intended that the scope of the invention be defined by the claims appended hereto, and their equivalents.

What is claimed is:

1. A coded video sequence conversion apparatus for converting a first bitstream provided by performing compression coding of a video signal of interlaced scanning in macro block units into a second bitstream based on a coding system subjected to compression coding in macro block units, the coded video sequence conversion apparatus comprising:
a decoding section that decodes a first code sting to provide a decoded image and a first coding parameter set;
a coding parameter set conversion section that converts, for each of pairs of macro blocks concerning the second bitstream adjacent to each other in a vertical direction on the decoded image, the first coding parameter set of each of corresponding macro blocks concerning the first bitstream corresponding to each pair on the decoded image to find a conversion coding parameter set;
a coding parameter set selection section that selects the conversion coding parameter set found relative to the pair as a second coding parameter set of each of the macro blocks of the pair; and
a coding section that performs compression coding of the decoded image using the second coding parameter set selected by said coding parameter set selection section to generate the second bitstream.

2. The coded video sequence conversion apparatus according to claim 1 further comprising a coding parameter set generation section that generates a coding parameter candidate set using the decoded image or the already generated second bitstream,
wherein the coding parameter set selection section selects the second coding parameter set of each of the macro blocks of the pair from among the coding parameter candidate sets and the conversion coding parameter sets.

3. The coded video sequence conversion apparatus according to claim 1, wherein the first coding parameter set contains at least one of:
coding structure information indicating which of a field structure and a frame structure the coding structure of the macro block is;
prediction type information indicating the prediction type of the macro block; and
DCT type information indicating the DCT type of the macro block,
Wherein the second coding parameter set and the conversion coding parameter set contain DCT type information indicating the DCT type of the macro block, and
wherein the coding parameter set conversion section sets the coding structure information of the conversion coding parameter set based on at least one of:
coding structure information of the corresponding macro block;
prediction type information of the corresponding macro block; and
DCT type information of the corresponding macro block.

4. The coded video sequence conversion apparatus according to claim 3, wherein the coding parameter set conversion section comprises:
an extraction section that extracts the coding structure information of the first coding parameter set of each of the corresponding macro blocks corresponding to each pair;
a comparison section that compares between the number of the corresponding macro blocks each having the value indicating a field structure and the number of the corresponding macro blocks each having the value indicating a frame structure about the coding structure information of each pair extracted by the extraction section; and
a setting section that sets the value indicating the field structure in the coding structure information of each macro block of the pair when the numbers equal as the comparison result of the comparison section, sets the value indicating the field structure in the coding structure information of each macro block of the pair when the number of the corresponding macro blocks each having the value indicating a field structure is larger than the number of the corresponding macro blocks each having the value indicating a frame structure, and sets the value indicating the frame structure in the coding structure information of each macro block of the pair when the number of the corresponding macro blocks each having the value indicating a frame structure is larger than the number of the corresponding macro blocks each having the value indicating a field structure.

5. The coded video sequence conversion apparatus according to claim 3, wherein the coding parameter set conversion section comprises:
an extraction section that extracts the coding structure information of the first coding parameter set of each of the corresponding macro blocks corresponding to each pair;
a determination section that determines whether or not the corresponding macro blocks each having the value indicating a field structure exist about the coding structure information of each pair extracted by the extraction section; and
a setting section that sets the value indicating the field structure in the coding structure information of each macro block of the pair when the corresponding macro blocks having the value indicating the field structure exists, and sets the value indicating the frame structure in the coding structure information of each macro block of the pair when all of the corresponding macro blocks have the value indicating the frame structure.

6. The coded video sequence conversion apparatus according to claim 3, wherein the coding parameter set conversion section comprises:
an extraction section that extracts the coding structure information of the first coding parameter set of each of the corresponding macro blocks corresponding to each pair;
an evaluation value calculation section that classifies the corresponding macro blocks corresponding to each pair according to the value of the coding structure information of the first coding parameter set and finding the evaluation value for each class using the first coding parameter set of the corresponding macro block belong to the class; and
a setting section that sets the coding structure information of each macro block of each pair in response to the evaluation value.

7. The coded video sequence conversion apparatus according to claim 6, wherein the coding parameter set conversion section further comprises a comparison section that compares between the number of the corresponding macro blocks each having the value indicating a field structure and the number of the corresponding macro blocks each having the value indicating a frame structure about the coding structure information of each pair extracted by the extraction section,
wherein the setting section of the coding parameter set conversion section sets the value indicating the field structure in the coding structure information of each macro block of the pair wherein the numbers equal as the comparison result of the comparison section and sets the value indicating the coding structure of the macro block of the higher evaluation value in the coding structure information of each macro block of the pair wherein the numbers differ.

8. The coded video sequence conversion apparatus according to claim 6, wherein the evaluation value calculation section in the coding parameter set conversion section performs:
calculating corresponding areas of the macro blocks having the field structure and the frame structure and corresponding to the second video coded video sequence; and
calculating evaluation values for each of the macro blocks having the field structure and the frame structure in accordance with the calculated corresponding areas.

9. The coded video sequence conversion apparatus according to claim 6, wherein the setting section of the coding parameter set conversion section sets the value indicating the field structure in the coding structure information of each macro block of the pair when the evaluation value of the corresponding macro block having field structure is not less than the evaluation value of the corresponding macro block having frame structure, and otherwise sets the value indicating the frame structure in the coding structure information of each macro block of the pair.

10. The coded video sequence conversion apparatus according to claim 6, wherein the setting section of the coding parameter set conversion section sets the value indicating the field structure in the coding structure information of each macro block of the pair when a value obtained by adjusting the evaluation value of the corresponding macro block having field structure with a predetermined weighting factor is not less than the evaluation value of the corresponding macro block having frame structure, and otherwise sets the value indicating the frame structure in the coding structure information of each macro block of the pair.

11. The coded video sequence conversion apparatus according to claim 10, wherein the setting section of the coding parameter set conversion section adjusts the weighting value uniquely or adaptively in accordance with coding information included in the first bitstream to be converted and coding information for the converted bitstream.

12. The coded video sequence conversion apparatus according to claim 1, wherein the first coding parameter set, the second coding parameter set, and the conversion coding parameter set contain each coding structure information indicating which of a field structure and a frame structure the coding structure of the macro block is,
wherein the coding parameter set conversion section comprises:
a coding structure information comparison section that compares between the coding structure information of each macro block of the pair and the coding structure information of each of the corresponding macro blocks; and
a coding structure information conversion section that converts the first coding parameter set contained in the corresponding macro block relative to the pair wherein the coding structure information differs in conformity with the coding structure of each macro block of the pair.

13. The coded video sequence conversion apparatus according to claim 12, wherein the coding structure information conversion section executes conversion so as to scale a motion vector contained in the corresponding macro block relative to the pair wherein the coding structure information differs in conformity with a time base.

14. The coded video sequence conversion apparatus according to claim 2, wherein the coding parameter set generation section generates a coding parameter candidate set containing:
information concerning intraframe coding;
information concerning macro block skip; and
information concerning direct prediction coding.

15. The coded video sequence conversion apparatus according to claim 2, wherein the first coding parameter set contains prediction type information indicating each of the corresponding macro blocks is interframe-coded or intraframe-coded in the first bitstream, and
wherein the coding parameter set generation section comprises:
a calculation unit that calculates the motion vector prediction value for the macro block from motion vector information of the macro block in the second bitstream already subjected to compression coding in the surroundings of the macro block of the second bitstream about the intraframe-coded macro block of the corresponding macro blocks; and
a setting unit that sets the calculated motion vector prediction value about the intraframe-coded macro block of the corresponding macro blocks as a coding parameter candidate of the macro block.

16. The coded video sequence conversion apparatus according to claim 2, wherein the coding parameter set selection section selects a coding parameter set based on the sum of absolute differences of prediction error signals generated using the coding parameter candidate set and the conversion coding parameter set.

17. The coded video sequence conversion apparatus according to claim 2, wherein the coding parameter set selection section selects a coding parameter set based on rate distortion characteristic when compression coding is performed using the coding parameter candidate set and the conversion coding parameter set.

18. The coded video sequence conversion apparatus according to claim 2, wherein the coding parameter set selection section selects a coding parameter set based on the generated code amount when compression coding is performed using the coding parameter candidate set and the conversion coding parameter set.

19. The coded video sequence conversion apparatus according to claim 1 further comprising a resolution conversion section that converts resolution of an image included in the first bitstream.

20. A coded video sequence conversion method for converting a first bitstream provided by performing compression coding of a video signal of interlaced scanning in macro block units into a second bitstream based on a coding system subjected to compression coding in macro block units, the method comprising:
a decoding step of decoding the first code sting to provide a decoded image and a first coding parameter set;
a coding parameter set conversion step of converting, as for a pair of macro blocks of the second bitstream adjacent to each other in a vertical direction on the decoded image, the first coding parameter set of each of corresponding macro blocks of the first bitstream corresponding to the pair on the decoded image to find a conversion coding parameter set;
a coding parameter set selection step of selecting the conversion coding parameter set found relative to the pair as a second coding parameter set of each of the macro blocks of the pair; and
a coding step of performing compression coding of the decoded image using the second coding parameter set selected in said coding parameter set selection step to generate the second bitstream.

21. The coded video sequence conversion method according to claim 20 further comprising a coding parameter set generation step of generating a coding parameter candidate set using the decoded image or the already generated second bitstream,
wherein, in the coding parameter set selection step, the second coding parameter set of each of the macro blocks of the pair from among the coding parameter candidate sets and the conversion coding parameter sets, is selected.

22. A computer-readable program product for causing a computer system to execute processing of converting a first bitstream provided by performing compression coding of a video signal of interlaced scanning in macro block units into a second bitstream based on a coding system subjected to compression coding in macro block units, the program product for causing the computer system to execute process comprising:
a decoding step of decoding the first code sting to provide a decoded image and a first coding parameter set;
a coding parameter set conversion step of converting, as for a pair of macro blocks of the second bitstream adjacent to each other in a vertical direction on the decoded image, the first coding parameter set of each of corresponding macro blocks of the first bitstream corresponding to the pair on the decoded image to find a conversion coding parameter set;
a coding parameter set selection step of selecting the conversion coding parameter set found relative to the pair as a second coding parameter set of each of the macro blocks of the pair; and
a coding step of performing compression coding of the decoded image using the second coding parameter set selected in said coding parameter set selection step to generate the second bitstream.

23. The program product according to claim 22, further causes the computer system to execute process comprising a coding parameter set generation step of generating a coding parameter candidate set using the decoded image or the already generated second bitstream,
wherein, in the coding parameter set selection step, the second coding parameter set of each of the macro blocks of the pair from among the coding parameter candidate sets and the conversion coding parameter sets, is selected.
